(19) United States
(12) Patent Application Publication
(10) Pub. No.: US 2006/0102092 A1
(43) Pub. Date: May 18, 2006

(54) Portable pet care system

(75) Inventor: Angelina Maria Cortez, Decatur, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Kitty2Go!, Inc., Atlanta, GA (US)

(21) Appl. No.: 11/266,068

(22) Filed: Nov. 3, 2005

Related U.S. Application Data
(60) Provisional application No. 60/624,772, filed on Nov. 3, 2004.

(51) Int. Cl. A01K 1/03

(52) U.S. Cl. 119/498

(57) ABSTRACT

A portable pet care system comprises a first end or base portion having a bottom and four side walls, a second end or top portion having a cover and four side walls, and a collapsible extension portion for placement between the two end portions and having four side walls, one of which has a pet-accessible opening. When the portable pet care system is in a travel configuration, the collapsible portion is adapted to fold up and fit entirely within the first and second end portions, which are sized to fit one within the other to define a travel box. The travel box contains liners, pet litter, a scoop, and a handle. When the portable pet care system is in an in-use configuration, the end and collapsible extension portions assemble into a disposable litter box or pet carrying container.

### CROSS-REFERENCE TO RELATED APPLICATION

This application claims the benefit of and priority to U.S. Provisional Patent Application No. 60/624,772, filed Nov. 3, 2004, entitled “Portable Cat Litter Box Kit” by Angelina Maria Cortez, which is incorporated herein by reference in its entirety.

### FIELD OF THE INVENTION

The present invention relates generally to the field of pet care, and more particularly, to portable multi-use pet care systems, devices, and travel kits.

### BACKGROUND OF THE INVENTION

Litter boxes are used as a depository for domesticated animal excrement. Conventional litter boxes are designed following a standard rectangular shape made of plastic having no top, which exposes the contents of the box. This provides easy access to the litter for the animal. However, some newer box designs have a cover or lid that conceals the waste and helps to better control odor, litter, and waste spills. For the sake of convenience, moving the conventional box from one location to the next is often inconvenient and certainly provides no discreetness. The additional element of sanitizing and maintenance present another set of responsibilities.

Conventional litter boxes are generally formed out of plastic and are comprised of four walls and a bottom. This design provides no mechanism for odor control and litter concealment nor does it lend itself to being disposable or compact for the sake of portability.

Travelers who happen to be pet owners often desire to take their small animals that utilize litter boxes with them on trips. On such occasions, once the pet has left the confines of its home, it is often left with no place to relieve itself. These small animals, if let loose to use a public grassy, concrete, or wooded area, could run off, get lost, or be endangered by motor vehicles. Currently, the only options that are available to the owner or caretaker is to bring a large and bulky litter box from home and discard it at some point during the trip. The list of inconvenient circumstances gets longer as the traveler who is planning a trip must consider when they have a small pet that must travel.

The major drawback with conventional litter boxes is that there are other components (e.g., litter, scoop, lines, etc.) that must be obtained. Issues of refilling and sanitation are also a concern. The sanitation/clean-up of the litter must occur at least once a week. When travelers who board cruise liners desire to take their pets, lack of available product on the market (i.e., on the ship) to purchase in a problem. Typically, these travelers must make alternate plans for the care of their pets.

Conventional litter boxes are also cumbersome and embarrassing to carry around. Further, conventional litter boxes that have been used at home are not typically clean enough or sanitized for use by a traveler.

There have been numerous designs and devices introduced to the public over the last century with the intention of providing a simple solution to the industry of portable animal waste control.

For example, U.S. Pat. No. 4,553,671, issued to Cheesman, discloses a disposable cat litter container having the animal litter prepackaged within the container. A prepackaged litter box with a separate cover that is used for shipping and not to prevent spills of litter and waste. As pointed out by Williamson in U.S. Pat. No. 4,792,082 “The shipping and storing configuration are unacceptably large. In addition the depth of the box is inadequate for the animal to cover the waste.” Although waterproofing is implemented, the lack of depth and no covering member (hood) for the masking of odors, concealment of the contents of the box and the issue of litter and waste being ejected from the box still provides no full solution to the consumers dilemma.

U.S. Pat. No. 4,164,314, issued to Edgar, discloses a single use disposable cat litter package. This does not lend itself to being cost effective for travelers when they are on extended trips lasting 5 to 7 days or more. As cited in Edgar's background, “Disposable containers have been tried and used on a limited basis but many of these have had certain inherent disadvantages, such as the unreliability of the container to retain the particle litter material, instability of the container structure, and the excess expense of providing a dependable, disposable container each time the litter is discarded.”

U.S. Pat. No. 4,792,082, issued to Williamson discloses “An enclosed box structure which contains several features permitting storage and shipment of litter within the box until needed, a removable cover which will allow the box to be service for a short period of time . . . ” Portable and compact, measuring 16×14×16 when unassembled provides one of the better designs that may provide a quick solution to a traveler. However, the absence of waterproofing, or added components such as the liners gives way to leaks and spills that are inherent in designs lacking multiple layers of protections from leaks, provided that the structure is made of paper or cardboard. Furthermore, the accidental spillage of litter and waste is not solved by the 2 inch depth of Williamson's claim. Although it may be argued that it is supplemented by the use of the triangular roof that attaches to the box that provides and enclosure, the 2 inch barrier at the front of the design where the animal enters the structure leaves a large area for litter and waste to be ejected when the animal is burying its waste.

There have been numerous patents issued for improvements to the litter box as a method of animal excrement disposal. However, there is a need for a compact and portable, multi-use pet care system having a top cover to prevent the escape of undesirable odors with waterproof or water resistant interior surfaces to prevent accidental waste spillage or leaks. Further, there is a need for a system that is convenient to use outdoors or indoors, in a variety of settings. There is yet a further need for a system that provides any traveler with the ability to provide their animal or pet with a clean and environmentally safe litter box. There is a need for a portable and disposable litter box system that can be used by motels, hotels, airports, cruise lines, and for automobile travel that is convenient, inexpensive, and easy to use.

Therefore, a heretofore unaddressed need exists in the art to address the aforementioned deficiencies and inadequacies.

### SUMMARY OF THE INVENTION

The present invention, in one aspect, relates to a portable pet care system. In one embodiment, the portable pet care system comprises: a first end having a bottom and four side walls disposed perpendicularly thereto, a second end having a cover and four side walls disposed perpendicularly thereto, and a collapsible extension having four side walls defining a pet compartment therein. When the portable pet care system is in a travel configuration, the collapsible portion is adapted to fold up and fit entirely within the first end and the second end and wherein the first end and the second end are sized to fit one in the other. When the portable pet care system is in an in-use configuration, a bottom portion of the collapsible extension mounts onto the four side walls of the first end. The second end is adapted to mount onto a top portion of the collapsible extension. One of the side walls of the collapsible extension includes an opening therethrough that provides access to the pet compartment.

In one embodiment, the portable pet care system is formed from a paperboard blank. In another embodiment, the paperboard blank is a corrugated paper or fiberboard.

In one embodiment, the portable pet care system further comprises a plastic liner for placement within the one end portion, pet litter for placement within the liner, and a pet litter scoop. The liner, pet litter, and pet litter scoop are contained entirely within the first end and the second end when the portable pet care system is in a travel configuration.

In one embodiment, the interior surface of the first end is waterproof. In another embodiment, the interior surface of the first end is water resistant.

In one embodiment, one of the end portions comprises a handle. The other end portion comprises a handle opening to the handle through which the handle extends when the portable pet care system is in travel configuration.

In another aspect, the present invention relates to a method of constructing a portable pet care system a first end, a second end, a collapsible extension, a plastic pet liner. In one embodiment, the method comprises the steps of: A method of assembling a portable pet care system having a top, a base, a collapsible extension that define walls of a compartment, and a pet liner, and wherein the top and base mate to form a travel kit within which the collapsible extension and pet liner are contained and wherein the collapsible extension includes an opening through one of the walls, comprising the steps of: opening the travel kit by separating the base from the top, removing the collapsible extension and the pet liner from the travel kit, placing the base on a relatively flat surface, lining the pet liner within the base, opening the collapsible extension from a collapsed configuration to an expanded configuration, mounting the collapsible extension onto a top edge of the base, and mounting the top onto a top edge of the collapsible extension.

In one embodiment, the step of installing the plastic pet liner into the inside of the first end further comprises a step of wrapping the top edge of the plastic liner over the top edge of four side walls of the first end. In another embodiment, the step of installing the plastic pet liner into the inside of the first end further comprises a step of spreading pet litter inside of the plastic liner. In one embodiment, the step of installing the collapsible extension onto the top edge of the first end further comprises a step of alternately inserting the tabs of the collapsible extension inside and outside of the top edge of four side walls of the first end.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a top plan view of a blank from which a first end of the portable pet care system is formed according to one embodiment of the present invention.

FIG. 2 is a top plan view of an optional enhancement portion of the portable pet care system according to one embodiment of the present invention.

FIG. 3 is a top plan view of a blank from which a second end of the portable pet care system is formed according to one embodiment of the present invention.

FIG. 4 is a plan view of a blank from which a collapsible extension of the portable pet care system is formed according to one embodiment of the present invention.

FIG. 5 is a perspective view of portable pet care system in a portable travel configuration according to one embodiment of the present invention.

FIG. 6 is a perspective view of an assembly process of components of a portable pet care system according to one embodiment of the present invention.

FIG. 7 is a perspective view of portable pet care system in an in-use configuration according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

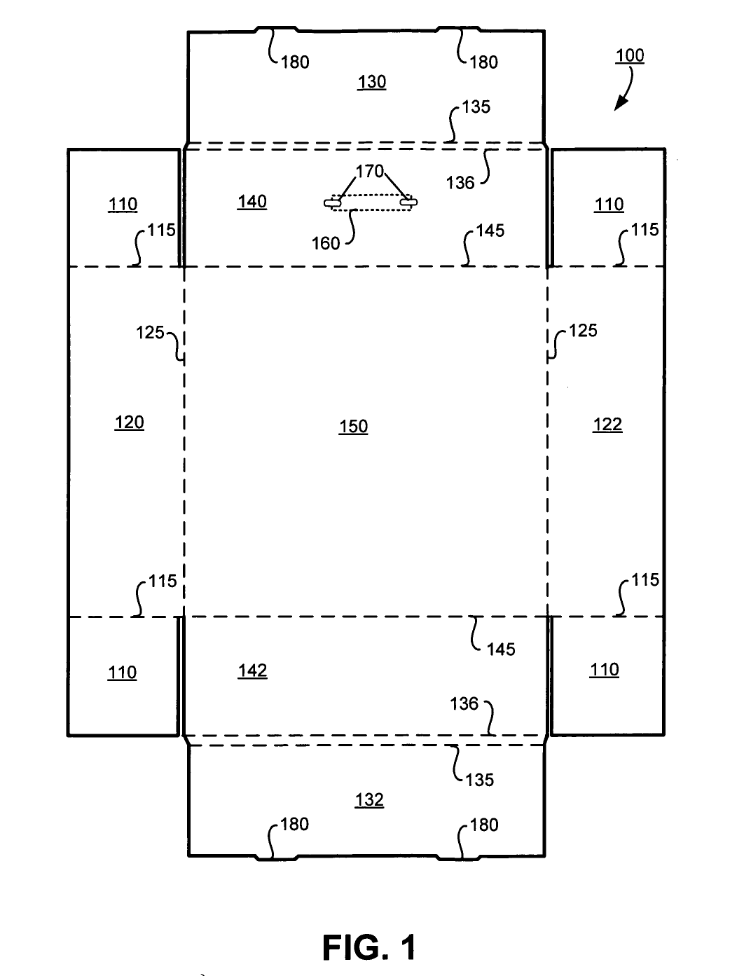

The description will be made as to the embodiments of the present invention in conjunction with the accompanying drawings in FIGS. 1-7. In accordance with the purposes of this invention, as embodied and broadly described herein, this invention, in one aspect, relates to a portable pet care system. The portable pet care system comprises: a first end 100 having a bottom and four side walls disposed perpendicularly thereto, a second end 300 having a cover and four side walls disposed perpendicularly thereto, and a collapsible extension 400 having four side walls defining a pet compartment therein, one of the side walls of the collapsible extension having a pet-accessible opening.

Referring now to FIG. 1, a drawing of the first end 100 is shown before it is folded to form the first end 100 according to one embodiment of the present invention. The first end 100 comprises a center portion 150 as the bottom of the first end 100, four side walls 120, 122, 140 and 142, two tabs 110 attached to the side wall 120, two tabs 110 attached to the side wall 122, one tab 130 attached to the side wall 140, one tab 132 attached to the side wall 142, and two oval holes 170 for attaching a handle 160. All dotted lines are perforating lines.

When the first end 100 is assembled, the tabs 110 are folded towards the side walls 120 and 122 along the perforating lines 115 such that the tabs 110 are perpendicular to the side walls 120 and 122. Then the side walls 120 and 122 are folded up towards center portion 150 along the perforating lines 125 such that the side walls 120 and 122 are perpendicular to the center portion 150. The side walls 140 and 142 are folded up towards the center portion 150 along the perforating lines 145 such that the side walls 140 and 142 are perpendicular to the center portion 150. The tabs 130 is then folded towards the side wall 140 along the perforating lines 135 and 136 such that the tab 130 is parallel to the side wall 140 with the folded tabs 110 between the side wall 140 and tab 130. The tab 132 is then folded towards the side wall 142 along the perforating lines 135 and 136 such that the tabs 132 are parallel to the side wall 142 with the folded tab 110 between the side wall 142 and tab 132. Finally, the handle 160 is attached to the two handle holes 170.

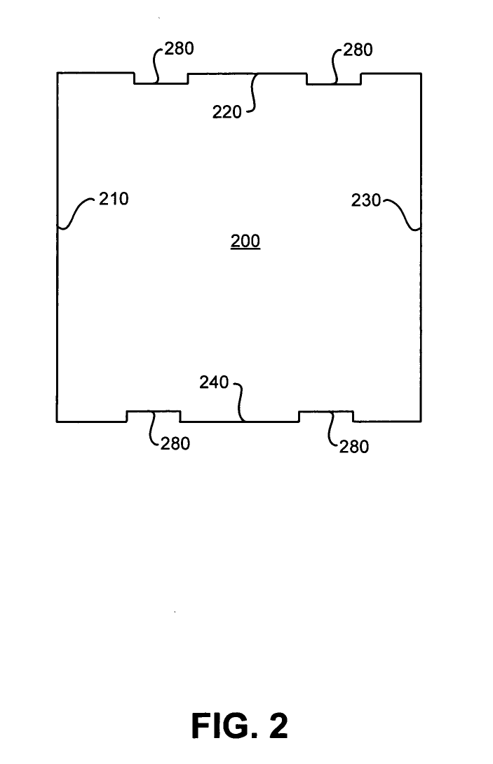

An enhance portion 200 is shown in FIG. 2. The enhance portion 200 is preferably added to the inside of the first end 100 for strength, stability, reinforcement, and to maintain the tabs 180, as described hereinafter. The enhance portion 200 comprises a flat board having a first edge 210, a second edge 220, a third edge 230 and a fourth edge 240. There are two notches 280 on the edges 220 and 240. When the enhance portion 200 is installed into the assembled first end 100, the notches 280 of the enhanced portion holds the tabs 180 of the first end 100.

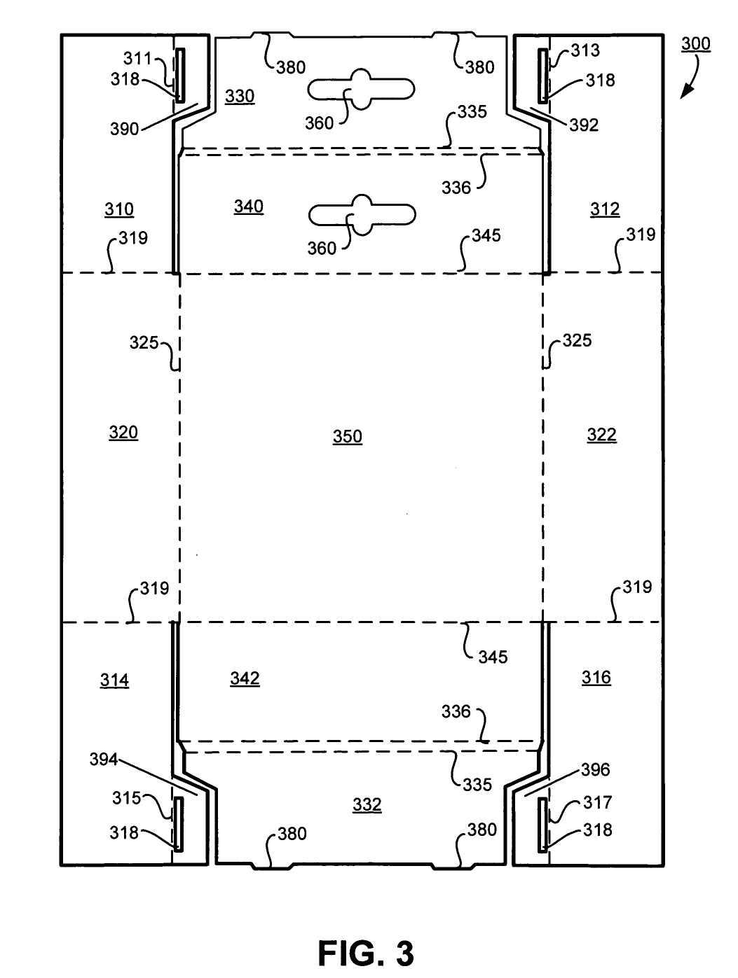

Referring now to FIG. 3, a drawing of the second end 300 is shown before it is folded to form the second end 300 according to one embodiment of the present invention. The second end 300 comprises a center portion 350 as the cover of the second end 300, four side walls 320, 322, 340 and 342, two tabs 310 and 314 attached to the side wall 320, two tabs 312 and 316 attached to the side wall 322, one tab 330 attached to the side wall 340, one tab 332 attached to the side wall 342, and two handle openings 360 are formed on the side wall 340 and the tab 330. There are four additional tabs 390, 392, 394 and 396 attaching to the four tabs 310, 312, 314, and 316. An opening 318 is formed on each of four tabs 310, 312,314, and 316. All dotted lines are perforating lines.

When the first end is assembled, the tabs 390, 392, 394 and 396 are folded towards the tabs 310, 312, 314, and 316 respectively along the perforating lines 311, 313, 315 and 317, respectively, such that the tabs 390,392, 394 and 396 are perpendicular to the tabs 310, 312, 314, and 316, respectively. Then the tabs 310 and 314 are folded towards the side wall 320 and the tabs 312 and 316 are folded towards the side wall 322, along the perforating lines 319, respectively, such that the tabs 310 and 314 are perpendicular to the side wall 320 and the tabs 312 and 316 are perpendicular to the side wall 322, respectively. The side walls 320 and 340 are folded towards the center portion 350 along the perforating lines 325 such that the side walls 320 and 322 are perpendicular to the center portion 350. The side walls 340 and 342 are folded up towards the center portion 350 along the perforating lines 345 such that the side walls 340 and 342 are perpendicular to the center portion 350. The tab 330 is then folded towards the side wall 340 along the perforating lines 335 and 336 such that the tab 330 is parallel to the side wall 340 with the folded tabs 310 and 312 in between the side wall 340 and tab 330. The notches 380 of the tab 330 are then inserted into the openings 318 to firmly hold the tabs 390, 392, 310, 312, 330 and 340 together. The tab 332 is folded towards the side wall 342 along the perforating lines 335 and 336 such that the tab 332 are parallel to the side wall 342 with the folded tabs 314 and 316 in between the side wall 342 and tab 332. The notches 380 of the tab 332 are then inserted into the openings 318 to firmly hold the tabs 394, 396, 314, 316, 332 and 342 together. The second end 300 is fully assembled.

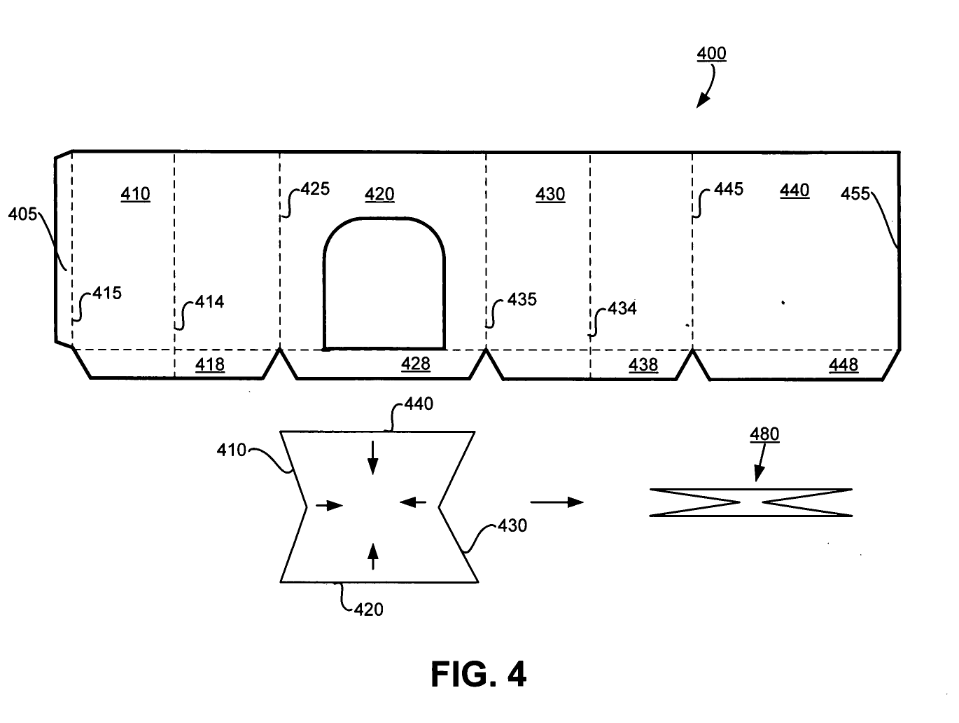

Now referring to FIG. 4, a diagram of a collapsible extension 400 is shown before it is assembled according one embodiment of the present invention. The collapsible extension 400 comprises four panels 410, 420, 430 and 440 with attached tabs 418, 428, 438 and 448. There is an opening 426 of the panel 420 for ingress and egress of pets. All dotted lines are perforating lines.

The collapsible extension 400 is formed by attaching folded edge of tab 405 of the panel 410 to an edge 455 of the panel 440, by gluing, stapling or with any other affixing means to attach them together. The perforating line 415 is lined up with the edge 455 of the panel 440. After such an attachment, the four panels become a four sided wall unit. When the portable pet care system is in travel configuration, the collapsible extension 400 is collapsed into a shape as illustrated as 480. When the portable pet care system is in in-use configuration, the collapsible extension is installed on top of the first end 100 of the portable pet care system with alternately putting the tabs 418, 428, 438, and 448 inside and outside of the first end 100 to hold the collapsible extension on top of the first end 100. The second end 300 is then installed on top of the collapsible extension 400.

The portable pet care system is formed from a paperboard blank. Such a paperboard blank comprises corrugated paper or fiberboard. In one embodiment, the interior surfaces of the first end 100 are waterproof. In another embodiment, the interior surfaces of the first end 100 are water resistant. Waterproofing is accomplished by using double-folded paperboard and a chemical treatment between or on at least one surface of the paperboard. Since the base or one end portion of the system is preferably prefolded and assembled prior to purchase, joints of the base can also be sealed or caulked using a water-proof sealant.

The portable pet care system further comprises a liner. The liner is installed in the inside of the first end 100 to prevent liquid or litter leakage and to improve the waterproof and water resistant aspects of the system.

The portable pet care system further comprises a predetrmined amount of pet litter. Preferably, when the system is originally sold and in travel configuration, the pet litter is contained in a storage bag or container that fits entirely within the two end portions that define the travel box. When in use or in an in-use configuration, the pet litter is transferred from its bag or container and spread, preferably, inside of the liner that is placed in one of the end portions.

The portable pet care system further includes a pet litter scoop that, preferably, fits within the travel box or attached to an outside panel of the travel box. Optionally, a pet waste bag may be included as part of the system or kit contents.

One of the first end and the second end is smaller than the other so that the smaller one can be fit into the large one to create the travel box. When the portable pet care system is in travel configuration, one or more liners, the pet litter, the pet litter scoop, and the collapsible extension are stowed into the smaller of the two end portions. The large one covers the small one to create the travel box or kit.

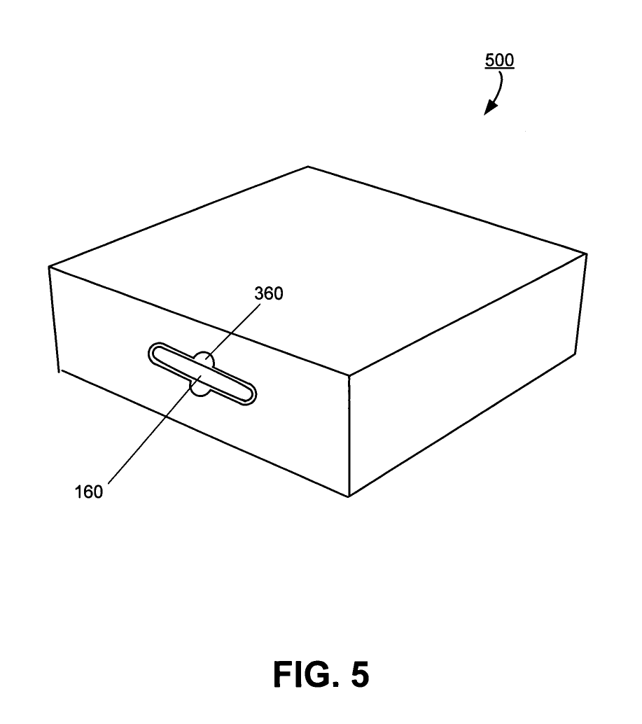

Now referring to FIG. 5, a travel configuration of the portable pet care system is shown according to one embodiment of the present invention. The handle 160 of the portable pet care system 500 is installed on the small end portion and is designed to extend through an opening 360 on the large end portion.

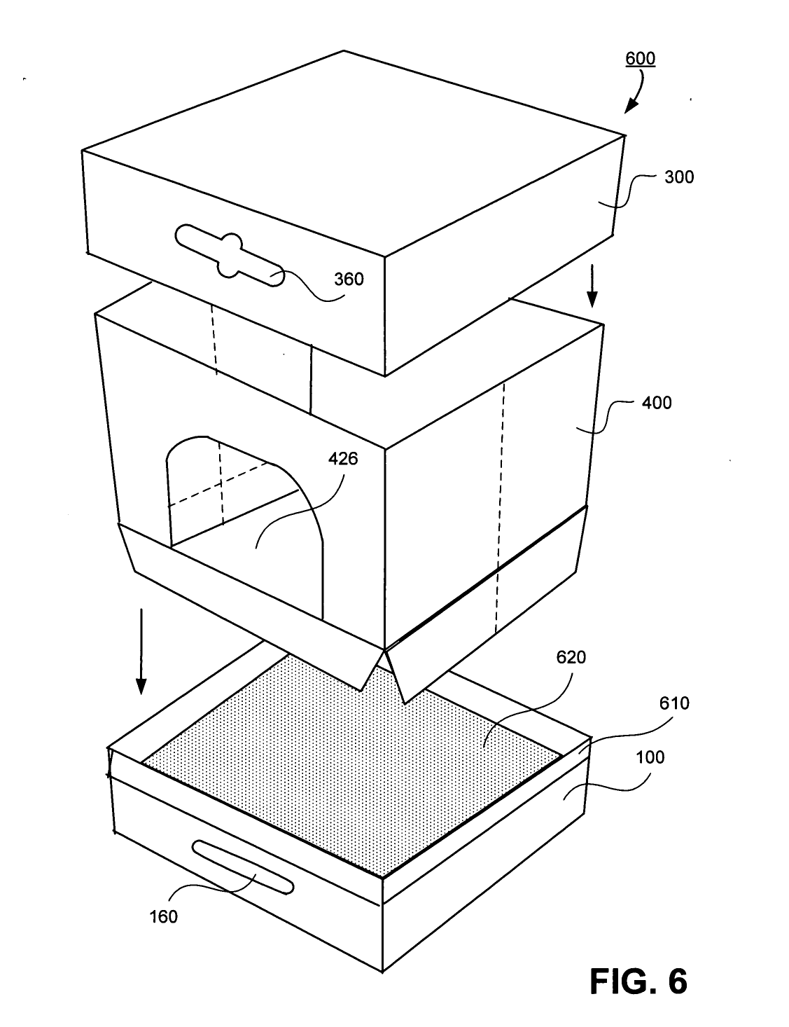

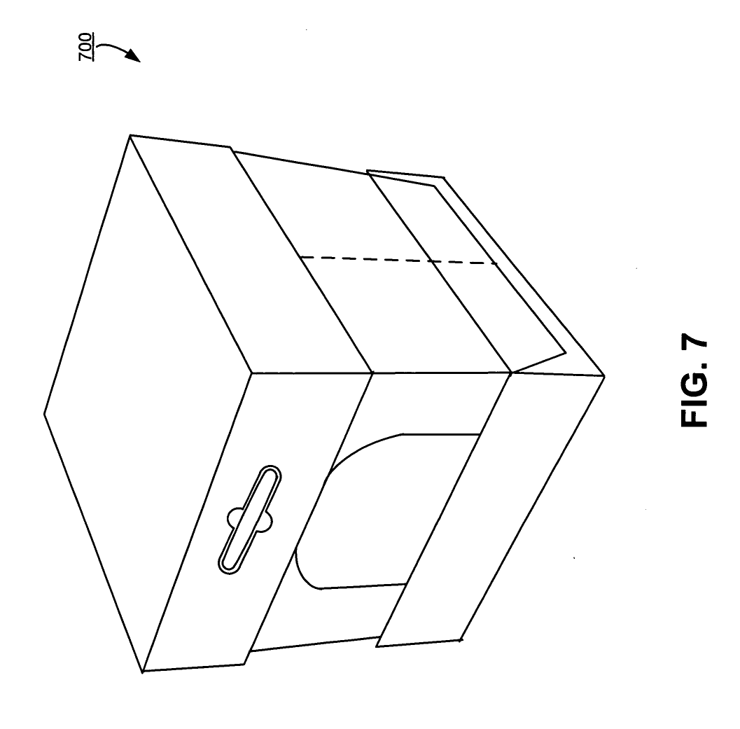

Now referring to FIG. 6, an installation procedure is illustrated according to one embodiment of the present invention. The portable pet care system 600 comprises a first end 100, a second end 300, a collapsible extension 400, a pet litter scoop (not shown), a pet litter liner 610, and pet litter 620. The pet litter liner 610 is used to line the inside of the first end 100 to cover the various walls and surfaces of the first end, and the pet litter 620 is spread inside the pet litter liner 610. The collapsible extension 400 is then installed on top of the first end 100 to define a pet compartment. The second end 300 is then installed on top of the collapsible extension 400. FIG. 7 shows a perspective view of a portable pet care system 700 in an in-use configuration.

Finally, the outer surfaces of the pet care container may include labels and branding of the company, hotel, motel, cruise line, etc. offering or selling the kit to their customers or branding for other third party vendors.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A portable pet care system, comprising:
a. a first end having a bottom and four side walls disposed perpendicularly thereto;
b. a second end having a cover and four side walls disposed perpendicularly thereto; and
c. a collapsible extension having four side walls defining a pet compartment therein;
wherein, when the portable pet care system is in a travel configuration, the collapsible portion is adapted to fold up and fit entirely within the first end and the second end and wherein the first end and the second end are sized to fit one in the other; and
wherein, when the portable pet care system is in an in-use configuration, a bottom portion of the collapsible extension mounts onto the four side walls of the first end, the second end is adapted to mount onto a top portion of the collapsible extension, and one of the side walls of the collapsible extension includes an opening therethrough that provides access to the compartment.

2. The portable pet care system of claim 1 comprising a paperboard blank.

3. The portable pet care system of claim 2, wherein the paperboard blank is made of corrugated paper or fiberboard.

4. The portable pet care system of claim 1 further comprising a plastic liner for placement within the first end and for receipt of litter material thereupon.

5. The portable pet care system of claim 4 wherein the plastic liner is shaped to line the bottom and four side walls of the first end.

6. The portable pet care system of claim 1 further comprising pet litter.

7. The portable pet care system of claim 1 further comprising a pet litter scoop.

8. The portable pet care system of claim 1, wherein the interior surface of the first end is waterproof.

9. The portable pet care system of claim 1, wherein the interior surface of the first end is water resistant.

10. The portable pet care system of claim 1, wherein one of the end portions comprises a handle.

11. The portable pet care system of claim 10, wherein the other end portion comprises a handle opening through which the handle extends when the portable pet care system is in travel configuration.

12. The portable pet care system of claim 1, further comprising a liner for placement within the one end portion, pet litter for placement within the liner, and a pet litter scoop, wherein the liner, pet litter, and pet litter scoop are contained entirely within the first end and the second end when the portable pet care system is in a travel configuration.

13. A method of assembling a portable pet care system having a top, a base, a collapsible extension that define walls of a compartment, and a pet liner, and wherein the top and base mate to form a travel kit within which the collapsible extension and pet liner are contained and wherein the collapsible extension includes an opening through one of the walls, comprising the steps of:
a. opening the travel kit by separating the base from the top;
b. removing the collapsible extension and the pet liner from the travel kit;
c. placing the base on a relatively flat surface;
d. lining the pet liner within the base;
e. opening the collapsible extension from a collapsed configuration to an expanded configuration;
f. mounting the collapsible extension onto a top edge of the base; and
g. mounting the top onto a top edge of the collapsible extension.

14. The method of claim 13, wherein the step of lining the pet liner within the base further comprises a step of wrapping the top edge of the pet liner over the top edge of four side walls of the first end.

15. The method of claim 13, wherein the step of lining the pet liner within the base further comprises a step of spreading pet litter inside of the plastic liner.

16. The method of claim 13, wherein the step of mounting the collapsible extension onto a top edge of the base further comprises a step of alternately inserting the tabs of the collapsible extension inside and outside of the top edge of four side walls of the first end.
